(19) United States
(12) Patent Application Publication
(10) Pub. No.: US 2011/0277294 A1
(43) Pub. Date: Nov. 17, 2011

(54) METER PULLER WITH SAFETY SHIELD

(76) Inventor: James R. Stillwagon, Columbus, OH (US)

(21) Appl. No.: 12/779,577

(22) Filed: May 13, 2010

(51) Int. Cl. B23P 19/00

(52) U.S. Cl. 29/426.5; 29/764

(57) ABSTRACT

A tool for installing and removing an electrical power meter comprising a sleeve member adapted for sliding movement about the meter and having a first end opposite a second end, a plurality of releasable gripping hooks mounted on the first end of the sleeve member for selectively engaging the meter, an attaching hook member extending outwardly from the first end of the sleeve member, and a shield secured to the second end of the sleeve member.

### BACKGROUND OF THE INVENTION

1. Technical Field

The invention relates generally to a tool for installing and removing electrical power meters. More particularly, the invention relates to a tool with a shield for removing electrical power meters. Specifically, the invention relates to a tool with a removable shield that can be used to protect a user while installing and removing electrical power meters.

2. Background Information

Electrical power meters must be occasionally removed and installed on electrical power distribution boxes or housings. The electrical meters can be removed by hand but there is a great deal of danger due to the high current, risk of electrocution, and electrical arc explosion that creates arc thermal energy and a pressure wave and fragmentation.

U.S. Pat. No. 5,097,581 is directed to an electrical power meter installing/removing apparatus that fits around the perimeter of the meter base and locks in place with snapping tabs. The operator then pulls back on the tool and removes the meter from the distribution box. While the apparatus includes a handle proximate the back end of the tool, the tool does not protect the user from electrocution or explosion which may occur at the connection between the power meter and the distribution box when the meter is removed.

### SUMMARY OF THE INVENTION

The present invention broadly comprises a tool for installing and removing an electrical power meter comprising a sleeve member adapted for sliding movement about the meter and having a first end opposite a second end, a plurality of releasable gripping hooks mounted on the first end of the sleeve member for selectively engaging the meter, an attaching hook member extending outwardly from the first end of the sleeve member, and a shield secured to the second end of the sleeve member.

The present invention also broadly comprises a method of removing an electrical power meter comprising the steps of providing a sleeve member having a first end with a plurality of releasable gripping hooks and an actuating hook member extending outwardly from the first end of the sleeve member and a second end with a handle, mounting a shield with a handle on the sleeve member second end, sliding the sleeve member onto the power meter until the attaching hook members surround a power meter gripping collar, grasping the second end handle and the shield handle, and pulling the sleeve member handle and the shield member in a direction away from the power meter.

### BRIEF DESCRIPTION OF THE DRAWINGS

The preferred embodiment of the invention, illustrative of the best mode in which Applicants have contemplated applying the principles of the invention, are set forth in the following description and are shown in the drawings.

FIG. 1 is a perspective view of a preferred embodiment sleeve member with releasable gripping hooks and attaching hooks;

FIG. 2 is a perspective view of a preferred embodiment sleeve member with safety shield having a handle;

FIG. 3A is an exploded view of a preferred embodiment sleeve member with intermediate member and connecting fasteners;

FIG. 3B is an exploded view of a preferred embodiment safety shield and handles;

FIG. 4 is a top plan view with the safety shield secured to the sleeve member;

FIG. 5 is a partial cross-sectional view of the sleeve member and safety shield taken generally about Line 5-5 in FIG. 4;

FIG. 6 is a partial cross-sectional view of the sleeve member taken generally about Line 6-6 in FIG. 4;

FIG. 7 is an operational view showing an operator gripping the handles and forcing the sleeve member and safety shield in the direction of a power meter;

FIG. 8 is an operational view showing the installer forcing the sleeve member on to the power meter; and,

FIG. 9 is an operational view of the operator removing the power meter with the sleeve member and an electrical explosion being deflected around the safety shield.

### DESCRIPTION OF THE PREFERRED EMBODIMENT

At the outset, it should be appreciated that like drawing numbers on different drawing views identify identical, or functionally similar, structural elements of the invention. While, the present invention is described with respect to what is presently considered to be the preferred embodiment, it is to be understood that the invention as claimed is not limited to the disclosed aspects.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

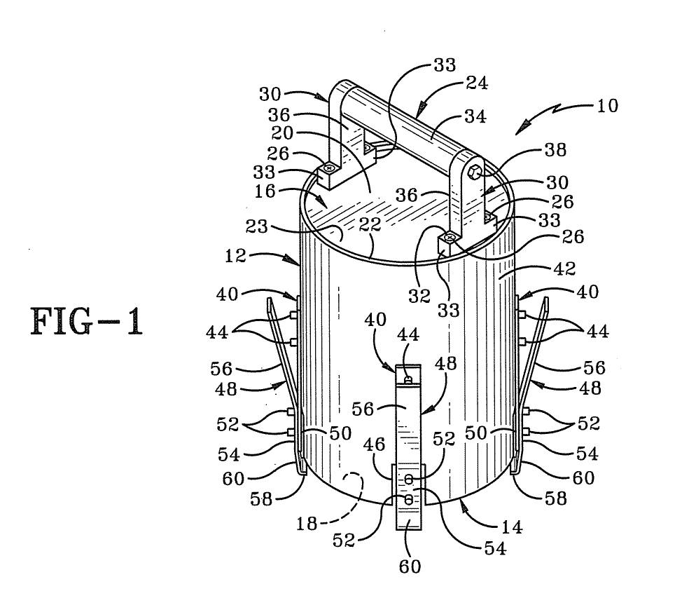

The tool of the present invention is indicated generally at 10, and is particularly shown in FIGS. 1 through 9. As particularly shown in FIG. 1, a sleeve member 12 includes a first end 14 opposing a second end 16. First end 14 includes an opening 18, while top end 16 is enclosed by a top surface 20. Further, top surface 20 is recessed within a lip portion 22 of sleeve member 12 which defines a cavity 23.

A handle 24 is connected to second end 16 through fasteners 26 and holes 28 (not shown in FIG. 1). Handle 24 generally consists of a pair of posts 30 having holes 32 on tabs 33 for receiving fasteners 26 and a central rod 34 disposed between inner surfaces 36 of post 30 and connected to the post with fasteners 38. Accordingly, handle 24 is removable by unscrewing fasteners 26.

Sleeve member 12 is preferably cylindrical in shape and formed of a rigid material such as plastic. In a preferred embodiment, four attachment hooks 40 are mounted on an outer surface 42 of sleeve member 12 with a pair of rivets 44. Attachment hooks 40 are preferably thin strips of metal which extend for approximately half of a length of the sleeve member and terminate proximate first end 14. Further, the width of the attachment hooks is preferably just smaller than guide opening 46 and first end 14.

A gripping hook 48 is secured to a terminal end 50 of attachment hook 40 with a pair of rivets 52 which may extend into guide opening 46. Gripping hooks 48 preferably include a flat portion 54 near the rivets and an angled portion 56 extending upward from the rivets to provide a lever arm for hook portion 58. Hook portion 58 is connected to flat portion 54 through lower angled portion 60. Hook portion 58 is preferably generally perpendicular to lower angled portion 60 so as to grip on to the power meter base. Further, angled portion 56 permits the hook portion 58 to be directed radially outward by compressing the angled portion 56 towards sleeve member outer surface 42.

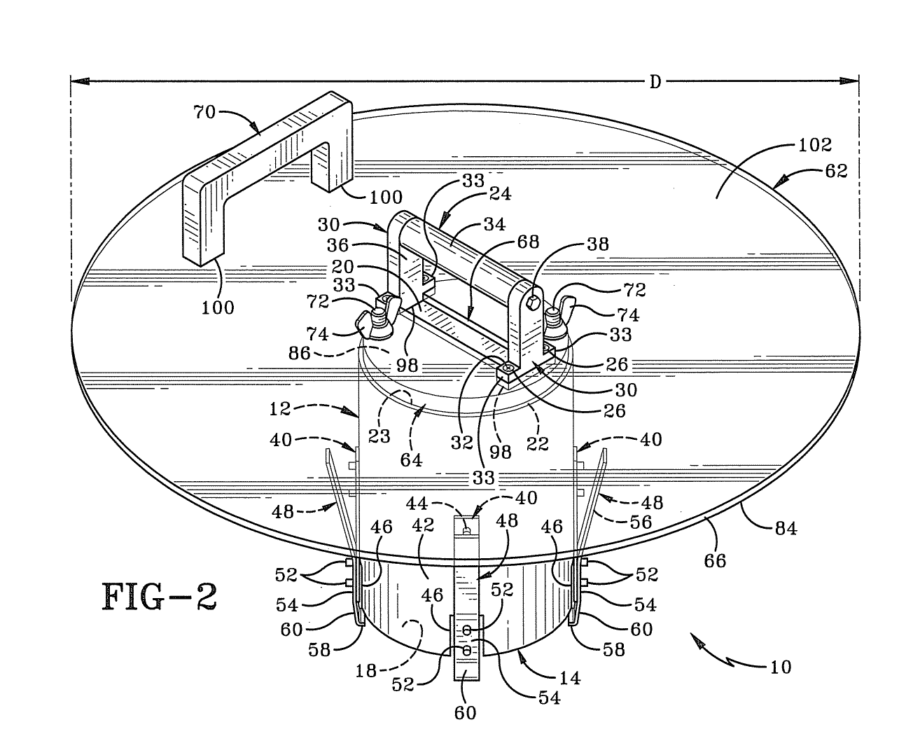

Referring now to FIG. 2, sleeve member 12 is shown with a shield 62 connected to sleeve member 12. Further, an intermediate member 64 is located between shield 62 and sleeve member second end 16. Shield 62 includes an outer surface 66 and a central opening 68. Central opening 68 is preferably sized and shaped complimentary to handle 24 so that the shield can be installed vertically around handle 24 when the handle is secured to sleeve member second end 16. Further, shield 62 also includes a handle 70 arranged generally perpendicular to second end handle 24 to provide a comfortable orientation for the operator. Shield 62 rests atop intermediate member 64 and is secured to the intermediate member and the sleeve member with threaded studs 72 and fasteners 74. Finally, shield 62 is preferably sized to protect an operator and may range anywhere from the diameter of sleeve member second end 16 to well over 24 inches. However, in a preferred embodiment the shield diameter is approximately 18 inches to 24 inches and is particularly 24 inches in the preferred embodiment. Shield 62 is preferably composed of a clear rigid plastic material that is capable of withstanding electrocution and a significant impact. Shield 62 may also be composed of a flame retardant transparent polycarbonate shield or may include a plurality of shields stacked one atop of the other.

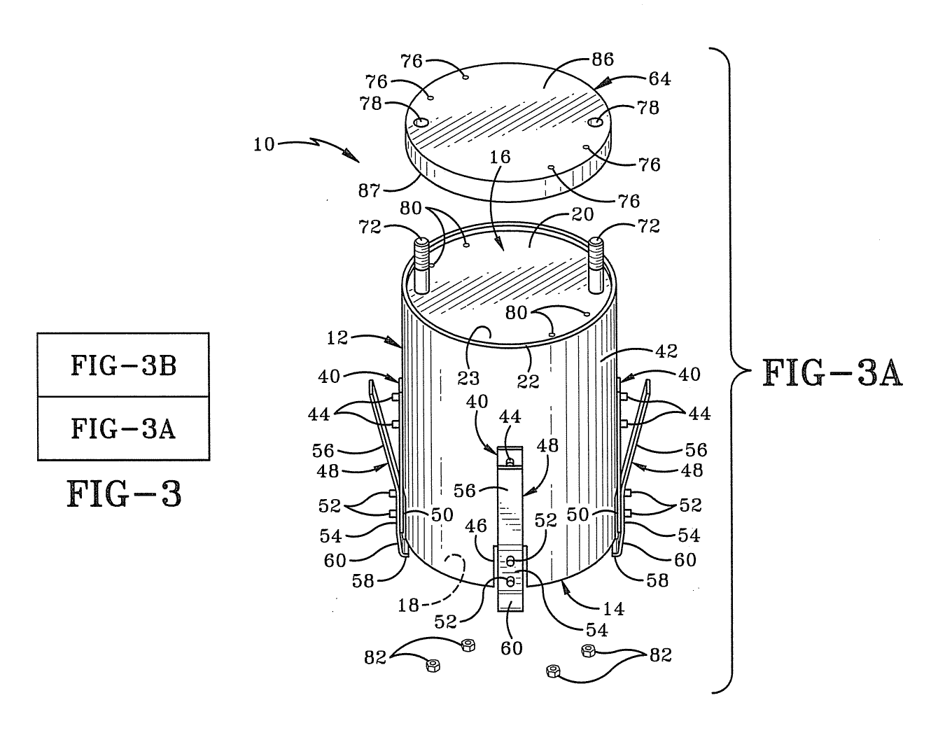

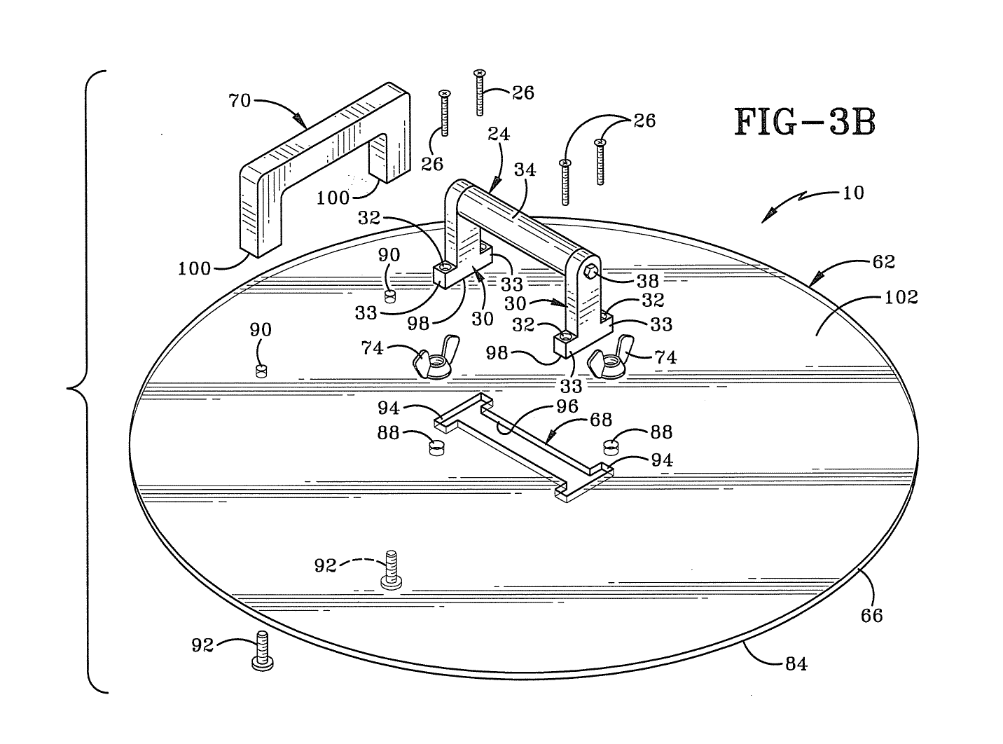

FIGS. 3A and 3B illustrate an exploded view of the first preferred embodiment tool 10. As can be particularly seen in FIG. 3A, intermediate member 64 is preferably cylindrical in shape and includes a plurality of holes 76 for receiving fasteners 26. A plurality of holes 78 permit threaded studs 72 to extend there through and secure shield 62 to sleeve member second end 16. Further, FIG. 3A illustrates a plurality of apertures 80 within second end 16 for receiving fasteners 26 of the handle as shown in FIG. 3B. Further, nuts 82 secure handle 24 and fasteners 26 to the intermediate member 64 and sleeve member 12. Intermediate member 64 is preferably cylindrical in shape and sized to fit within lip portion 22 of second end 16. Further, intermediate member 64 preferably has a thickness greater than the height of lip portion 22 to extend the shield contact surface above lip portion 22. Specifically, a bottom surface 84 of shield 62 contacts a top surface 86 of intermediate member above lip portion 22, while a bottom surface 87 of the intermediate member contacts top surface 20.

Referring specifically to FIG. 3B, safety shield 62 is shown with a pair of apertures 88 for receiving threaded studs 72 of second end 16. Shield 62 also includes a pair of apertures 90 for receiving fasteners 92 to connect handle 70 to shield 62. Further, central opening 68 is again shown complimentary shaped to handle 24 and includes a pair of rectangular openings 94 at each end and a slot 96 for permitting passage of handle central rod 34 during installation, while rectangular openings 94 permit passage of posts 30 during installation. Accordingly, a bottom surface 98 of post 30 rests flush with bottom surface 84 of shield 62 when fully installed, while a bottom surface 100 of handle 70 rests on a top surface 102 of the shield after installation. Therefore, handle 70 is preferably shorter than handle 24 to ensure that the handles are aligned at the same height. In a preferred embodiment, handle 70 is shorter than handle 24 by the same thickness as shield 62.

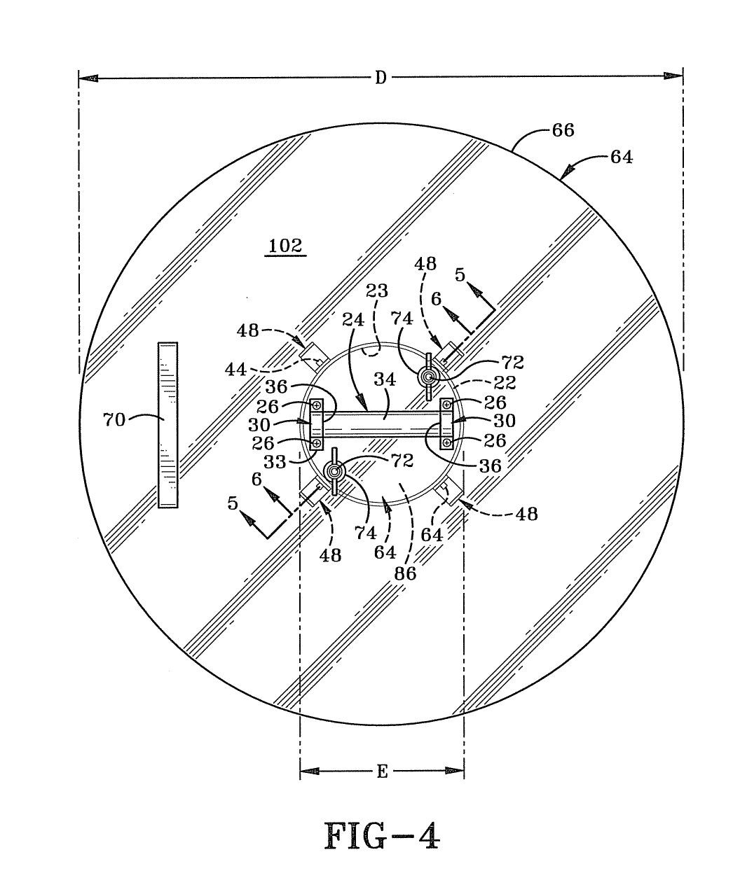

FIGS. 4, 5, and 6 illustrate the arrangement of the tool and shield components. As seen in FIG. 4, diameter D of shield 62 is preferably larger than diameter E of sleeve member 12. Further, the orientation of handle 24 with respect to handle 70 is seen in greater detail to allow the operator to more naturally use the meter puller and shield. Still further, this view illustrates the larger range of protection for the operator.

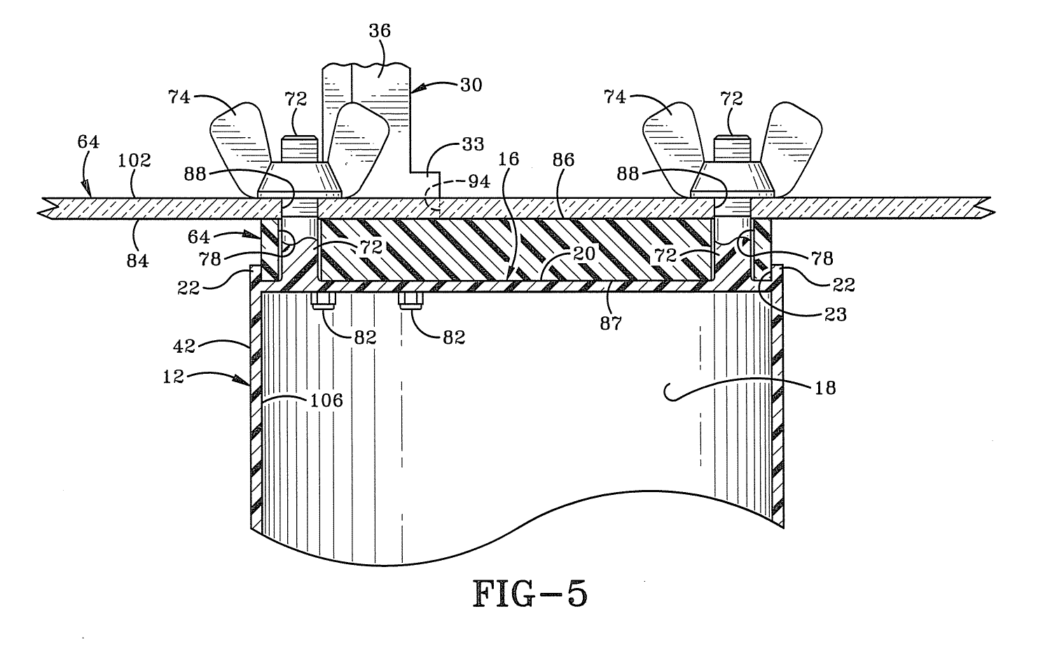

FIG. 5 illustrates a cross-sectional view showing second end 16 with studs 72 integral to the second end and intermediate member 64 surrounding the studs. FIG. 5 also illustrates opening 18 extending upward from first end 14 all the way to second end 16. Still further, this view illustrates lip portion 22 extending partially up the thickness of intermediate member 64 and intermediate member 64 extending far above lip portion 22. While studs 72 are shown integral to the second end, the stud could be removably secured to the second end with nuts.

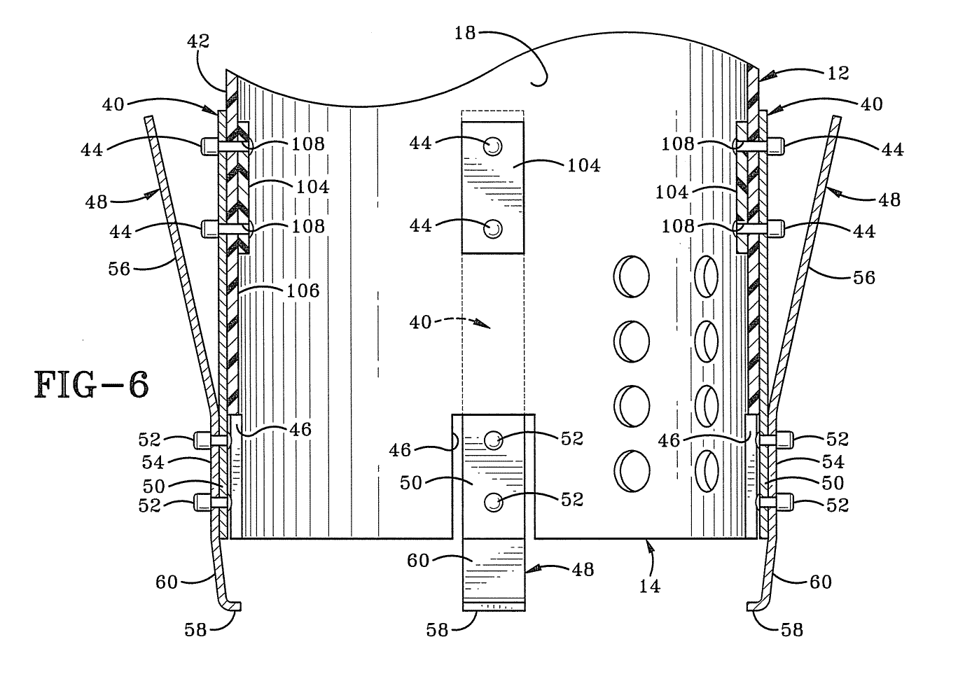

FIG. 6 illustrates a cross-sectional view of first end 14 illustrating gripping hook 48 secured to outer surface 42 of sleeve member 12 with rivets 44. In addition, an absorbing mount 104 is located proximate an inner surface 106 of sleeve member 12. Absorbing mount 104 preferably includes a pair of apertures 108 arranged to receive rivets 44 and particularly mount attachment hook 40 to sleeve member 12. Absorbing mount 104 is preferably constructed of a rigid plastic but may also be constructed of a more flexible material and is useful to reduce the bending moment that is created by operating angle portion 56.

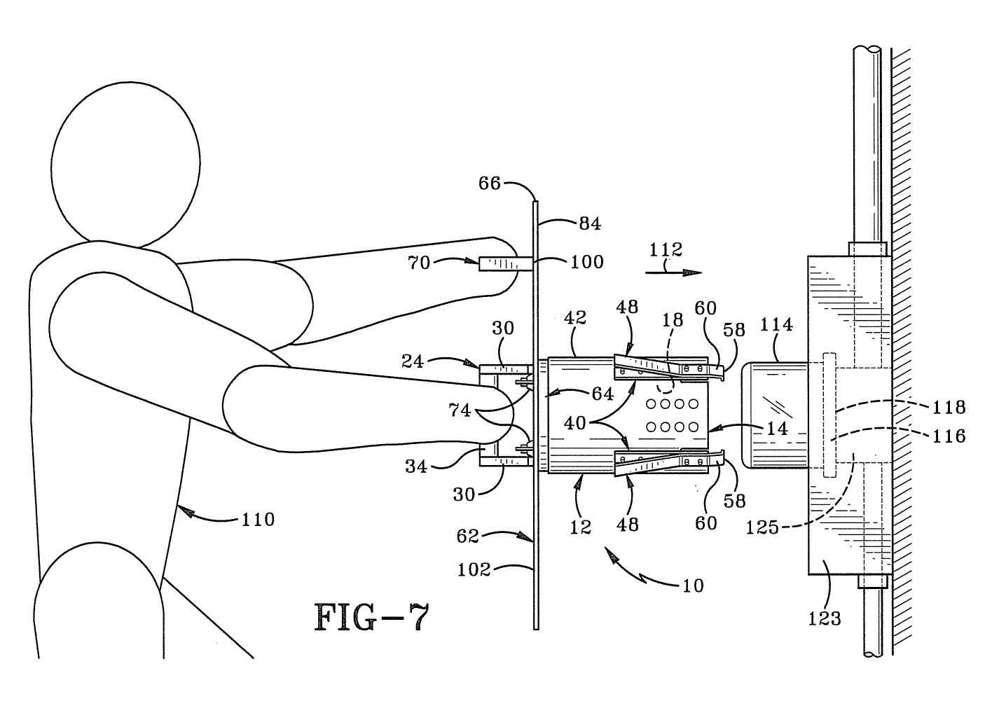

Having described the structure of the preferred embodiment, a preferred method of operation will be described in detail and should be read in light of FIGS. 1 through 9 and particularly FIGS. 7 through 9.

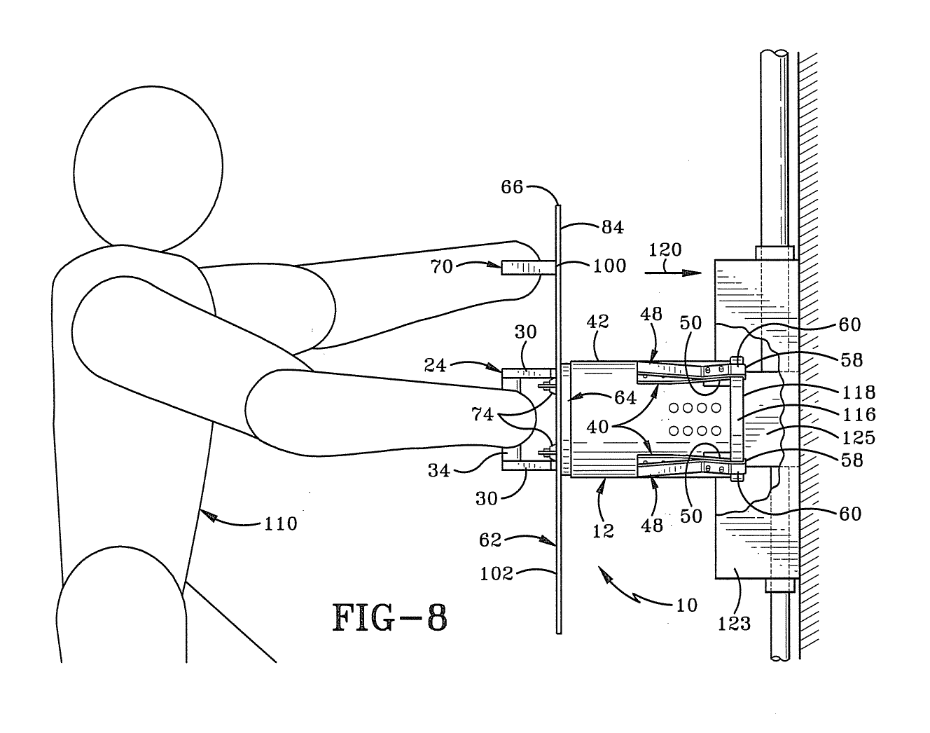

FIGS. 7 through 9 illustrate the operation of the meter puller after shield 62 has been secured on intermediate member 64 and second end 16 as shown in FIGS. 3A, 3B, and 5. Referring now to FIG. 7, an operator 110 grasps tool 10 at handles 24 and 70 and forces the tool in a direction associated with arrow 112 towards electrical power meter 114 having a base 116. As seen in FIG. 8, the operator forces the tool in a direction associated with arrow 120 until hook portion 58 surrounds and contacts a back surface 118 of meter base 116 and engages the tool with the meter for removal.

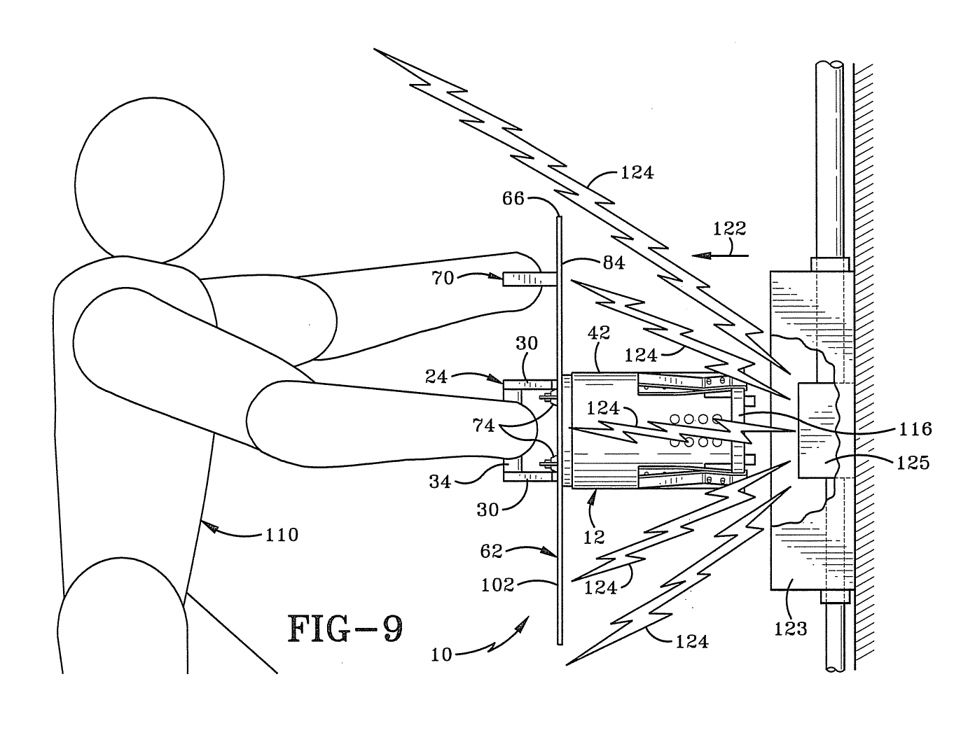

FIG. 9 illustrates removal of the electrical meter by pulling tool 10 in direction associated with arrow 122 away from a distribution box 123 and particularly meter mount 125. Should an electrical explosion or electrocution occur during the removal of meter 114, a blast 124 will be sent towards the operator and deflected by shield 62 or, due to the size of the shield, pass radially outward of the shield and thereby missing the operator. Advantageously, this shield arrangement provides a greater cone of protection for the operator to reduce the risk and damage that a blast may cause during electrical power meter removal and installation. Still further, the shield provides greater dexterity for the user in that there are two handles to guide the tool on to the power meter as well as during the removal and installation process.

Alternatively, the operator may use a strap wrench or other suitable tool to compress angled portions 56 on each gripping hook 48. Advantageously, using a strap wrench allows the operator to compress the gripping hooks and surround the power meter while reducing the operator's risk of being electrocuted.

Thus, tool 10 provides an apparatus for protecting a user as well as additional assistance during the installation and removal of electrical power meters. Further, the tool is easily transportable as shield 62 may be easily removed to allow for storage. The shield provides a cone of protection with greater heat attenuation for the user with increasing the user's control over the meter puller by using two hands.

It will be evident to one of skilled in the art that a variety of changes can be made that are within the spirit and scope of the present invention. For instance, the sleeve member and shield may be composed of the same or different materials and can be manufactured of a variety of colors, including translucent colors. Further, the size of the shield and the length of the sleeve member may be adjusted to accommodate specific users or specific power meters.

Accordingly, the power meter puller with safety shield is an effective, safe, inexpensive, and efficient device that achieves all the enumerated objectives of the invention, provides for eliminating difficulties encountered with prior art devices, systems, and methods, and solves problems and obtains new results in the art.

In the foregoing description, certain terms have been used for brevity, clearness, and understanding; but no unnecessary limitations are to be implied therefrom beyond the requirement of the prior art, because such terms are used for descriptive purposes and are intended to be broadly construed.

Moreover, the description and illustration of the invention is by way of example, and the scope of the invention is not limited to the exact details shown or described.

Having now described the features, discoveries, and principles of the invention, the manner in which the power meter puller with safety shield is constructed and used, the characteristics of the construction, and the advantageous new and useful results obtained; the new and useful structures, devices, elements, arrangement, parts, and combinations are set forth in the appended claims.

What is claimed is:

1. A tool for installing and removing an electrical power meter comprising:
a sleeve member adapted for sliding movement about the meter and having a first end opposite a second end;
a plurality of releasable gripping hooks mounted on the first end of the sleeve member for selectively engaging the meter;
an attaching hook member extending outwardly from the first end of the sleeve member; and,
a shield secured to the second end of the sleeve member.

2. The tool of claim 1 wherein the shield is removably secured to the second end of the sleeve member.

3. The tool of claim 1 wherein the sleeve member second end further comprises an outer perimeter and the shield further comprises an outer perimeter, wherein the shield outer perimeter extends radially outward of the sleeve member second end outer perimeter.

4. The tool of claim 1 wherein the shield further comprises an outer diameter of approximately 24 inches.

5. The tool of claim 1 wherein the shield further comprises a handle.

6. The tool of claim 5 wherein the handle is located radially outward of a mid-point between a central axis of the shield and an outer perimeter of the shield.

7. The tool of claim 5 wherein the sleeve member further comprises a sleeve handle and wherein the sleeve handle is aligned generally perpendicular to the shield handle.

8. The tool of claim 5 wherein the shield handle is removable from the shield.

9. The tool of claim 1 further comprising an intermediate member disposed between the sleeve member second end and the shield.

10. The tool of claim 9 wherein the intermediate member further comprises a plurality of apertures adapted to receive a plurality of studs.

11. The tool of claim 10 wherein the shield further comprises a plurality of apertures adapted to receive the plurality of studs.

12. The tool of claim 11 wherein a plurality of fasteners interconnect the plurality of studs, the intermediate member, and the shield.

13. The tool of claim 1 wherein the shield further comprises a central opening.

14. The tool of claim 13 wherein the central opening is shaped complementary to an outer perimeter of a sleeve handle connected to the sleeve member second end.

15. The tool of claim 13 wherein the central opening is positioned to surround a handle connected to the sleeve member second end.

16. The tool of claim 1 further comprising an absorbing mount and a rivet interconnecting each of the plurality of releasable gripping hooks and the sleeve member first end.

17. The tool of claim 16 wherein the absorbing mount is located within the sleeve member.

18. The tool of claim 1 wherein the shield deflects an explosion from the power meter around the shield.

19. A method of removing an electrical power meter comprising the steps of:
providing a sleeve member having a first end with a plurality of releasable gripping hooks and an attaching hook member extending outwardly from the first end of the sleeve member and a second end with a handle;
mounting a shield with a handle on the sleeve member second ends;
sliding the sleeve member onto the power meter until the attaching hook members surround a power meter gripping collar;
grasping the second end handle and the shield handle; and,
pulling the sleeve member handle and the shield member in a direction away from the power meter.

20. The method of claim 19 wherein the step of mounting the shield on the sleeve member second end further comprises the steps of:
locating the shield on a plurality of studs; and,
securing a plurality of fasteners on the plurality of studs.

21. The method of claim 19 further comprising the steps of:
maintaining the shield between a user and the power meter; and,
deflecting an explosion into and around the shield.
